(19) United States
(12) Patent Application Publication
(10) Pub. No.: US 2024/0189634 A1
(43) Pub. Date: Jun. 13, 2024

(54) Fall Protection Device

(71) Applicant: 3M INNOVATIVE PROPERTIES COMPANY, St. Paul, MN (US)

(72) Inventors: James R. Sommerville, Hudson, WI (US); Travis P. Betcher, Goodhue, MN (US); Michael N. Milbright, Red Wing, MN (US); Kenneth L. Yarina, St. Paul, MN (US)

(21) Appl. No.: 18/530,473

(22) Filed: Dec. 6, 2023

Related U.S. Application Data
(60) Provisional application No. 63/386,389, filed on Dec. 7, 2022.

(51) Int. Cl. A62B 35/00

(52) U.S. Cl. CPC A62B 35/0075; A62B 35/0093

(57) ABSTRACT

A fall-protection device for use with a safety harness of a user includes a housing configured to be connected to the safety harness. The fall-protection device further includes a lifeline extending from the housing. The lifeline includes a lifeline end distal to the housing and configured to be coupled to an anchor. The lifeline is retractable or extendable relative to the housing. The lifeline is extendable relative to the housing from a retracted state in which a length of the lifeline extending out of the housing is minimum. The fall-protection device further includes a flexible cover extending from the housing and coupled to the housing and the lifeline. The flexible cover at least partially encloses the lifeline. The flexible cover contracts or expands as the lifeline retracts or extends, respectively, relative to the housing.

### TECHNICAL FIELD

The present disclosure generally relates to safety equipment, and more particularly, relates to a fall-protection device.

### BACKGROUND

Fall-protection devices, such as self-retracting lifelines (SRL), are often used to enhance human safety when users are working at elevated heights or are otherwise at risk of falling. For example, users often wear safety harnesses connected to anchorages via the fall-protection device. Fall-protection devices typically include a lifeline (e.g., a cable made of steel) extending from a housing. Movement of the user causes the lifeline to extend from or retract into the housing.

During use, the lifeline of the fall-protection device may rub against the body (e.g., the arm) of the user and may cause injury to the user. Further, the lifeline may cause damage to workplace surroundings that may potentially come in contact with the lifeline, e.g., building materials. Moreover, the lifeline may catch on features of the safety harness, thereby restricting mobility and causing discomfort to the user.

### SUMMARY

In one aspect, the present disclosure provides a fall-protection device for use with a safety harness of a user. The fall-protection device includes a housing configured to be connected to the safety harness. The fall-protection device further includes a lifeline extending from the housing. The lifeline includes a lifeline end distal to the housing and configured to be coupled to an anchor. The lifeline is retractable or extendable relative to the housing. The lifeline is extendable relative to the housing from a retracted state in which a length of the lifeline extending out of the housing is minimum. The fall-protection device further includes a flexible cover extending from the housing and coupled to the housing and the lifeline. The flexible cover at least partially encloses the lifeline. The flexible cover contracts or expands as the lifeline retracts or extends, respectively, relative to the housing.

In another aspect, the present disclosure provides a fall-protection system including a safety harness configured to be worn by a user. The fall-protection system further includes an anchor and the fall-protection device of the first aspect. The lifeline of the fall-protection device is connected to the anchor and the housing of the fall-protection device is connected to the safety harness.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic view of a fall-protection system, according to an embodiment of the present disclosure;

FIG. 2 is a schematic perspective view of a fall-protection device, according to an embodiment of the present disclosure;

FIG. 3 is a schematic sectional view of the fall-protection device, according to an embodiment of the present disclosure;

FIG. 4A is a schematic side view of the fall-protection device in a retracted state of a lifeline and a contracted state of a flexible cover, according to an embodiment of the present disclosure;

FIG. 4B is a schematic side view of the fall-protection device in an extended state of the lifeline and an expanded state of the flexible cover, according to an embodiment of the present disclosure;

FIG. 5A is a schematic side view of the fall-protection device, according to another embodiment of the present disclosure;

FIG. 5B is a detailed schematic side view of a portion of the fall-protection device of FIG. 5A in the retracted state of the lifeline, according to an embodiment of the present disclosure;

FIG. 6A is a schematic perspective view of the fall protection device, according to yet another embodiment of the present disclosure; and

FIG. 6B is a schematic perspective view of the fall protection device of FIG. 6A in the extended state of the lifeline, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

According to aspects of this disclosure, a fall-protection device for use with a safety harness of a user includes a housing configured to be connected to the safety harness. The fall-protection device further includes a lifeline extending from the housing. The lifeline includes a lifeline end distal to the housing and configured to be coupled to an anchor. The lifeline is retractable or extendable relative to the housing. The lifeline is extendable relative to the housing from a retracted state in which a length of the lifeline extending out of the housing is minimum. The fall-protection device further includes a flexible cover extending from the housing and coupled to the housing and the lifeline. The flexible cover at least partially encloses the lifeline. The flexible cover contracts or expands as the lifeline retracts or extends, respectively, relative to the housing.

The fall-protection device of the present disclosure includes the flexible cover. The flexible cover at least partially encloses the lifeline, such the flexible cover may create a barrier between the lifeline and the user or the surroundings of the user (e.g., building material, etc.). Thus, the flexible cover may prevent the lifeline from directly contacting the body of the user or the surroundings, thereby preventing any injury to the user or damage to the surroundings.

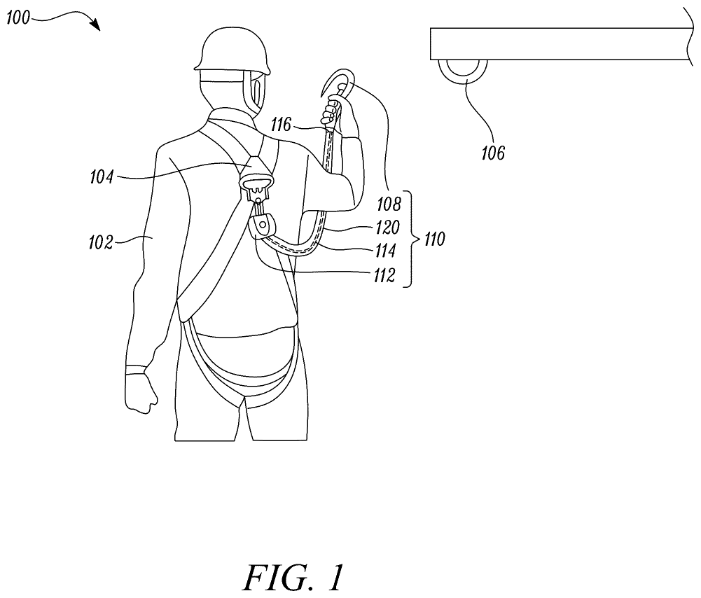

Further, the flexible cover may also prevent the lifeline from catching up on the safety harness of the user. Therefore, the fall-protection device of the present disclosure may improve comfort and mobility of the user while using the fall-protection device. Moreover, the flexible cover may contract or expand as the lifeline retracts or extends, respectively, relative to the housing. Thus, the flexible cover may at least partially enclose the lifeline at all times during usage of the fall-protection device. FIG. 1 illustrates a schematic view of an example of a fall-protection system 100. The fall-protection system 100 includes a safety harness 104 configured to be worn by a user 102. The fall-protection system 100 further includes an anchor 106. In some examples, the anchor 106 may be any suitable anchorage of a worksite. The fall-protection system 100 further includes a fall-protection device 110 for use with the safety harness 104 of the user 102.

The fall-protection device 110 includes a housing 112 configured to be connected to the safety harness 104. The fall-protection device 110 further includes a lifeline 114 extending from the housing 112. The lifeline 114 includes a lifeline end 116 distal to the housing 112 and configured to be coupled to the anchor 106. In some examples, the fall-protection device 110 may be a self-retracting lifeline (“SRL”) that includes a load-bearing line (referred to herein as a “lifeline”) that may be unwound from the housing 112.

In some examples, the lifeline 114 may be a tensioned cable. In some examples, the lifeline 114 may be a line that is configured to bear a weight of a human user (i.e., the user 102) and is further configured to withstand any momentarily higher force resulting, e.g., from the arresting of a fall of the human user. As used herein, the term “lifeline” broadly encompasses any cable, strap, webbing, rope, lanyard, and/or the like. In various embodiments, the lifeline 114 may be, e g., round or flat in cross-section. Further, the lifeline 114 may be made of any material, e.g., a metal, a polymeric material, a composite material, and so on.

In some examples, the fall-protection device 110 further includes a connector 108 coupled to the lifeline end 116. In some examples, the connector 108 is configured to detachably connect the lifeline 114 to the anchor 106. In some examples, the connector 108 may be detachably coupled to the lifeline end 116. In some examples, the connector 108 may be a hook or a gated hook. In some examples, the gated hook may include a gate hingedly connected to the hook. Such a gate may be biased toward a closed position such that the gated hook is self-locking.

In some examples, the gated hook may include a lock that holds the gate in the closed position and/or may include one or more actuators (e.g., handles, triggers or switches) that allow the gate to be unlocked and moved out of the closed position at a desired time. In some examples, the connector 108 may be made from a rigid material, e.g., a metal such as steel or aluminum, a mixture of metals (i.e., an alloy), and/or the like.

In some examples, the fall-protection system 100 as disclosed herein may act to arrest a fall of the user 102 in the event that a fall occurs. In some examples, the fall-protection system 100 may act to ensure that the user 102 is not subjected to a fall, e.g., does not come close enough to an edge of a rooftop to fall. In various embodiments, the fall-protection system 100 may be a vertical system that protects the user 102 during, e.g., climbing a ladder or a similar structure, or a horizontal system that protects the user 102 during, e.g., moving about a rooftop or a similar structure. Such safety systems are often referred to respectively as vertical lifelines (VLLs) and horizontal lifelines (HLLs).

It should be understood that the fall-protection system 100 as shown in FIG. 1 is described by way of example only. Other variations of the exemplary fall-protection system 100 of FIG. 1 are also within the scope of this disclosure (e.g., a twin-leg lanyard comprising two lifelines). Further, it should be understood that in alternative embodiments, the lifeline 114 may be coupled to the safety harness 104 and the housing 112 may be coupled to the anchor 106.

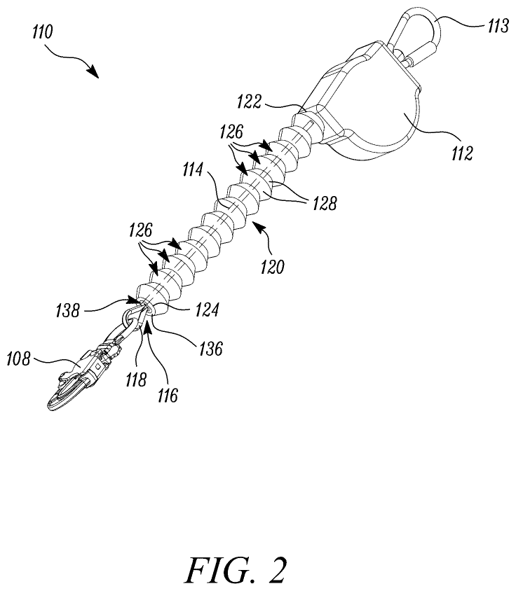

FIG. 2 is a schematic perspective view of the fall-protection device 110. The fall-protection device 110 further includes a flexible cover 120 extending from the housing 112 and coupled to the housing 112 and the lifeline 114. In some examples, the flexible cover 120 may be fixedly coupled to the housing 112 and/or the lifeline 114. In some examples, the flexible cover 120 is fully disposed outside the housing 112.

In some examples, the flexible cover 120 includes a first end 122 fixedly coupled to the housing 112. The flexible cover 120 further includes a second end 124 distal to the first end 122 and fixedly coupled to the lifeline 114 proximal to the lifeline end 116. In some examples, the flexible cover 120 includes bellows.

In some examples, the flexible cover 120 may be made of any suitable material, e.g., a metal, a polymer, a composite, etc. In some other examples, the flexible cover 120 may be made of a soft material, such as soft PVC or rubber. Further, the flexible cover 120 may have a diameter or a minimum width greater than a diameter of the lifeline 114, such that the flexible cover 120 at least partially encloses the lifeline 114.

In some examples, the lifeline 114 further includes a loop 118 at the lifeline end 116. In some examples, the loop 118 is connected to the connector 108. In some examples, the connector 108 is detachably connected to the loop 118. In some examples, the loop 118 is disposed outside the flexible cover 120 away from the housing 112. In some examples, the fall-protection device 110 further includes a housing connector 113 coupled to the housing 112. In some examples, the housing connector 113 may couple the housing 112 to the safety harness 104 (shown in FIG. 1).

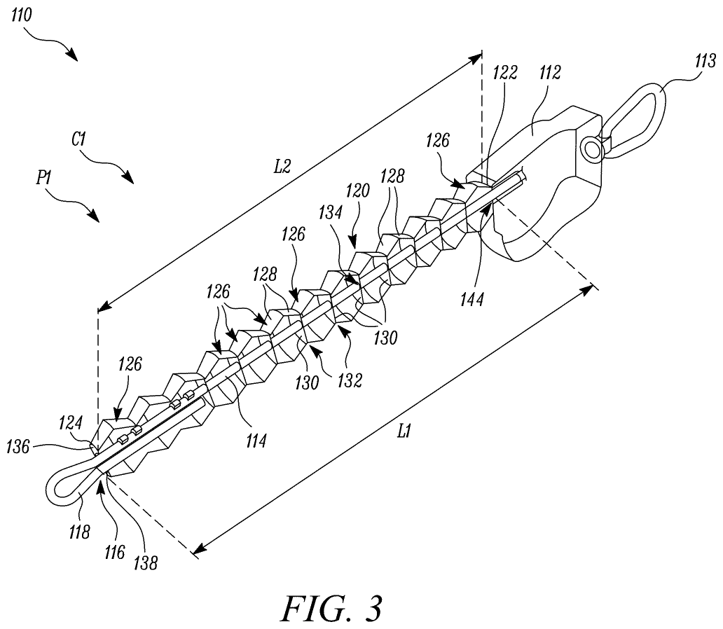

FIG. 3 is a schematic sectional view of the fall-protection device 110. Some components (e.g., the connector 108) of the fall-protection device 110 are not shown for the purpose of illustration. In some examples, the housing 112 includes a housing opening 144. The lifeline 114 extends through the housing opening 144. As shown in FIG. 3, the flexible cover 120 at least partially encloses the lifeline 114.

In some examples, the lifeline 114 defines a length L1. The length L1 represents a length of the lifeline 114 extending out of the housing 112. Similarly, the flexible cover 120 defines a length L2. The length L2 represents a length of the flexible cover 120 between the first end 122 and the second end 124 of the flexible cover 120.

Referring now to FIGS. 2 and 3, the lifeline 114 of the fall-protection device 110 is retractable or extendable relative to the housing 112. Specifically, FIG. 3 illustrates the fall-protection device 110 in a retracted state P1. In some examples, in the retracted state P1, the length L1 of the lifeline 114 extending out of the housing 112 is minimum. In some examples, in the retracted state P1, no pull force is exerted on the lifeline 114 by the housing 112 (e.g., through a biased spring). Thus, in the retracted state P1, the length L1 of the lifeline 114 extending out of the housing 112 may allow the lifeline 114 to be connected to the anchor 106 (shown in FIG. 1).

The flexible cover 120 contracts or expands as the lifeline 114 retracts or extends, respectively, relative to the housing 112. In the illustrated example of FIG. 3, the flexible cover 120 is in a contracted state C1 corresponding to the retracted state P1 of the lifeline 114. In some examples, in the contracted state C1, the length L2 of the flexible cover 120 is minimum.

In some examples, the flexible cover 120 further includes a plurality of sections 126 disposed adjacent to each other along the length L2 of the flexible cover 120. In some examples, each section 126 has a pair of adjoining frustoconical portions 128 tapering away from each other. In some examples, the section 126 disposed adjacent to the housing 112 is fixedly coupled to the housing 112. It should be understood that the flexible cover 120 may include any number of sections 126. Further, in alternative examples, the plurality of sections 126 of the flexible cover 120 may have any suitable shape, e.g., square, triangular, rectangular, oval, elliptical, polygonal, or the like based on application attributes. Further, it should be understood that one or more sections 126 from the plurality of sections 126 may also be different from each other. In some examples, each section 126 from the plurality of sections 126 of the flexible cover 120 contracts or expands as the lifeline 114 retracts or extends, respectively.

In some examples, the fall-protection device 110 further includes a plurality of walls 130. In some examples, the plurality of walls 130 are enclosed by the plurality of sections 126. In some examples, each wall 130 is connected to the corresponding adjacent sections 126. In some examples, each wall 130 from the plurality of walls 130 is disposed at a junction 132 between corresponding adjacent sections 126 from the plurality of sections 126.

In some examples, each wall 130 includes a wall opening 134 for at least partially and slidably receiving the lifeline 114 therethrough. In other words, the lifeline 114 is supported within the flexible cover 120 by the plurality of walls 130 through the wall opening 134 of each wall 130. In some examples, each wall 130 is disc shaped. However, in alternative examples, the wall 130 may have any suitable shape, e.g., triangular, rectangular, irregular, or the like.

In some examples, the fall-protection device 110 further includes an end wall 136 disposed proximal to the lifeline end 116 and fixedly coupled to the lifeline 114. In some examples, the end wall 136 is connected to the section 126 disposed proximal to the lifeline end 116. The end wall 136 defines an end wall opening 138 at least partially and slidably receiving the lifeline 114 therethrough. In some examples, the loop 118 at the lifeline end 116 may have a width greater than a diameter or a maximum width of the end wall opening 138, such that the end wall opening 138 prevents the loop 118, and therefore the lifeline 114, from retracting fully inside the housing 112.

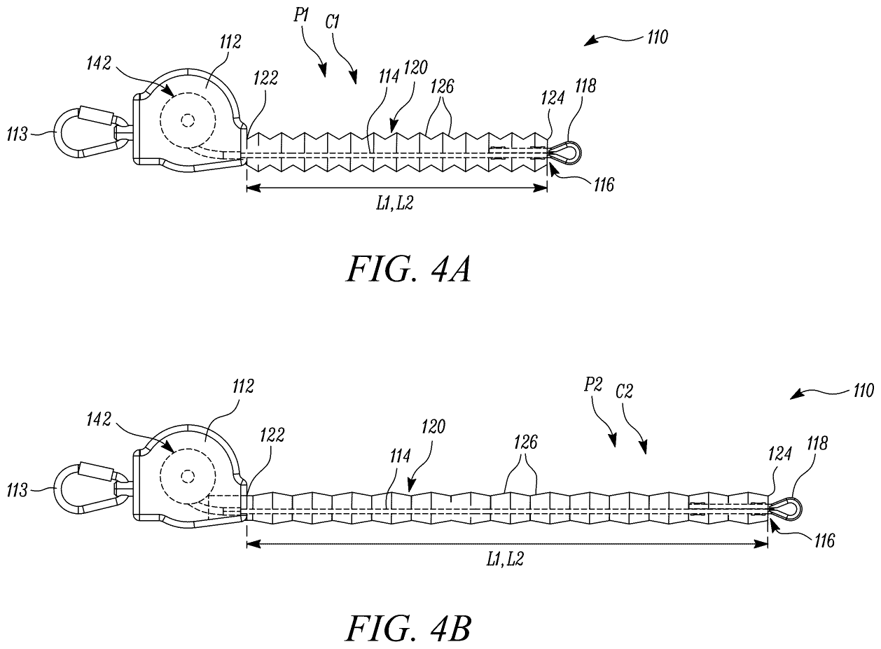

FIG. 4A is a schematic side view of the fall-protection device 110 in the retracted state P1 of the lifeline 114 and the contracted state C1 of the flexible cover 120. FIG. 4B is a schematic side view of the fall-protection device 110 in an extended state P2 of the lifeline 114 and an expanded state C2 of the flexible cover 120. Some components (e.g., the connector 108) of the fall-protection device 110 are not shown in FIGS. 4A and 4B for the purpose of illustration.

In some examples, the fall-protection device 110 further includes a drum 142 received within the housing 112 and rotatable relative to the housing 112. The drum 142 is shown schematically in FIGS. 4A and 4B for the purpose of illustration. In some examples, the lifeline 114 is at least partially wound around the drum 142. In some examples, the lifeline 114 winds on or unwinds from the drum 142 as the lifeline 114 retracts or extends, respectively, relative to the housing 112. Specifically, the lifeline 114 retracts or extends relative to the housing 112 based on rotation of the drum 142 relative to the housing 112.

In some examples, the drum 142 may be biased (e.g., by a torsion spring) to impart an appropriate rewind force such that the lifeline 114 may be extended from the housing 112 as the user 102 (shown in FIG. 1) moves away from the anchor 106 (shown in FIG. 1), and the drum 142 automatically retracts the lifeline 114 back into the housing 112 and rewinds the lifeline 114 about the drum 142 as the user 102 (shown in FIG. 1) moves toward the anchor 106 (shown in FIG. 1). Therefore, the lifeline 114 may allow the user (shown in FIG. 1) to move relative to the anchor 106 (shown in FIG. 1) when the lifeline 114 is coupled to the anchor 106 (shown in FIG. 1). In the illustrated example of FIGS. 4A and 4B, the drum 142 is shown by way of example only and other variations of the drum 142 are also within the scope of this disclosure.

As illustrated in FIG. 4A, the flexible cover 120 has a minimum length corresponding to the retracted state P1 of the lifeline 114, such that the flexible cover 120 restricts further retraction of the lifeline 114 into the housing 112 from the retracted state P1. The length L2 of the flexible cover 120 is minimum in the contracted state C1 of the flexible cover 120. The length L1 of the lifeline 114 in the extended state P2 (shown in FIG. 4B) is greater than that in the retracted state P1. Similarly, the length L2 of the flexible cover 120 in the expanded state C2 (shown in FIG. 4B) is greater than that in the contracted state C1.

As illustrated in FIG. 4B, the lifeline 114 is extendable relative to the housing 112 from the retracted state P1 shown in FIG. 4A in which the length L1 of the lifeline 114 extending out of the housing 112 is minimum. Further, as illustrated in FIG. 4B, the flexible cover 120 is expandable from the contracted state C1 shown in FIG. 4A in which the lifeline 114 is in the retracted state P1. Thus, the flexible cover 120 may move between the contracted state C1 (shown in FIG. 4A) and the expanded state C2 (shown in FIG. 4B) as the lifeline retracts or extends, respectively, relative to the housing 112. Therefore, the flexible cover 120 may at least partially enclose the lifeline 114 at all times during usage of the fall-protection device 110.

In some examples, the flexible cover 120 is configured to dampen a movement of the lifeline 114 as the lifeline 114 retracts relative to the housing 112. In other words, the flexible cover 120 is configured to dampen the movement of the lifeline 114 as the lifeline 114 moves from the extended state P2 (shown in FIG. 4B) to the retracted state P1 (shown in FIG. 4A). In some examples, the flexible cover 120 is configured to reset a unit (not shown) that is locked (e.g., inadvertently locked) as the lifeline 114 retracts relative to the housing 112.

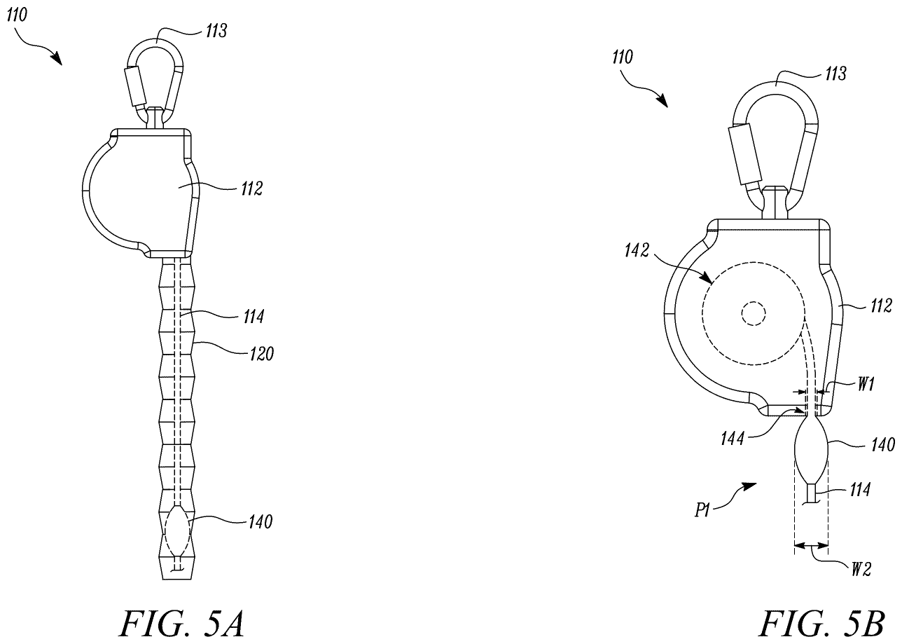

FIG. 5A is a schematic side view of another example of the fall-protection device 110. Some components (e.g., the connector 108) of the fall-protection device 110 are not shown in FIG. 5A for the purpose of illustration. In the illustrated example of FIG. 5A, the fall-protection device 110 further incudes a lifeline stop 140 coupled to and disposed around the lifeline 114. In some examples, the lifeline stop 140 is received within the flexible cover 120. In some examples, the lifeline stop 140 has an elliptical cross-section. However, in alternative examples, the lifeline stop 140 may have any cross-sectional shape, e.g., square, triangular, rectangular, oval, polygonal, irregular, or the like based on application attributes.

FIG. 5B is a detailed schematic side view of a portion of the fall-protection device 110 of FIG. 5A. Specifically, FIG. 5B illustrates the fall-protection device 110 is the retracted state P1 of the lifeline 114. Further, the flexible cover 120 of the fall-protection device 110 is omitted in FIG. 5B for the purpose of illustration.

In some examples, the lifeline stop 140 engages with the housing 112 in the retracted state P1 of the lifeline 114, such that the lifeline 114 is restricted from further retraction into the housing 112. For example, the lifeline stop 140 may be fixedly coupled to the lifeline 114 and may restrict the lifeline 114 from further retraction into the housing 112 from the retracted state P1. In some examples, the housing opening 144 has the maximum width W1 smaller than a maximum width W2 of the lifeline stop 140, such that the lifeline 114 is restricted from further retraction into the housing 112. In alternative examples, the lifeline stop 140 may have a circular cross-section with a diameter greater than the maximum width W1 of the housing opening 144.

Referring now to FIGS. 1 to 5B, the fall-protection device 110 of the present disclosure includes the flexible cover 120. The flexible cover 120 at least partially encloses the lifeline 114 such the flexible cover 120 may create a barrier between the lifeline 114 and the user 102 or the surroundings of the user 102. Thus, the flexible cover 120 may prevent the lifeline 114 from directly contacting the body of the user 102 or the surroundings, thereby preventing any injury to the user 102 or damage to the surroundings.

Further, the flexible cover 120 may also prevent the lifeline 114 from catching up on the safety harness 104 of the user 102. Therefore, the fall-protection device 110 of the present disclosure may improve comfort and mobility of the user 102 while using the fall-protection device 110. Moreover, the flexible cover 120 may contract or expand as the lifeline 114 retracts or extends, respectively, relative to the housing 112. Thus, the flexible cover 120 may at least partially enclose the lifeline 114 at all times during usage of the fall-protection device 110.

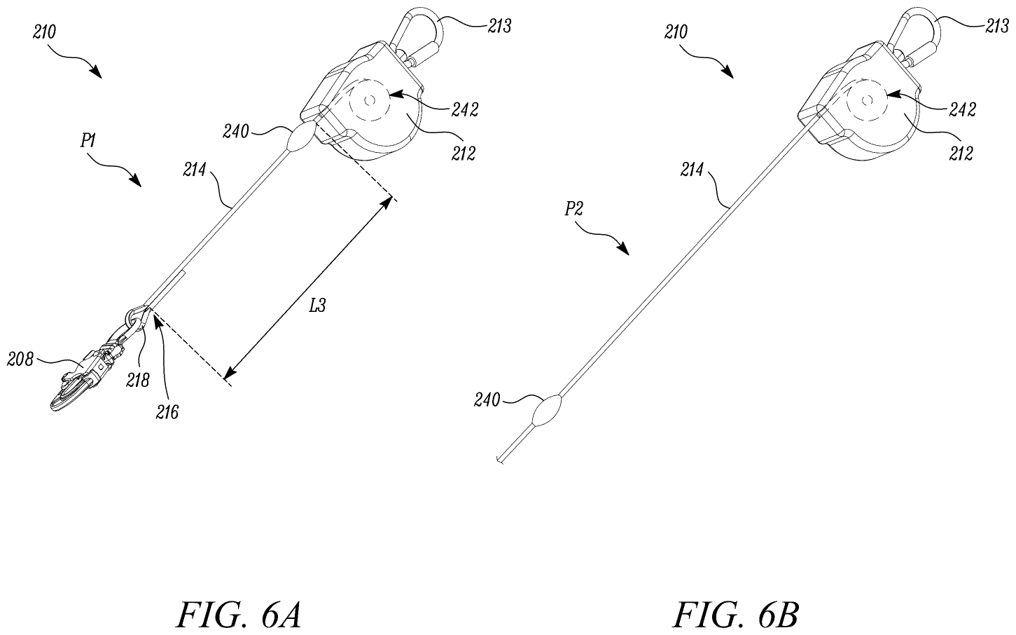

FIG. 6A is a schematic perspective view of another example of the fall-protection device 210. Specifically, the fall-protection device 210 does not include the flexible cover 120 of the fall-protection device 110 (shown in FIGS. 1-5A). The fall-protection device 210 includes a housing 212 configured to be connected to the safety harness 104 (shown in FIG. 1). In some examples, the fall-protection device 210 further includes a housing connector 213 coupled to the housing 212. In some examples, the housing connector 213 may couple the housing 212 to the safety harness 104 (shown in FIG. 1).

The fall-protection device 210 further includes a lifeline 214. The lifeline 214 includes a lifeline end 216 distal to the housing 212 and configured to be coupled to the anchor 106 (shown in FIG. 1). In some examples, the lifeline 214 further includes a loop 218 at the lifeline end 216. In some examples, the loop 218 is connected to a connector 208. In some examples, the connector 208 is detachably connected to the loop 218. In some examples, the connector 208 is configured to detachably couple the lifeline 214 to the anchor 106 (shown in FIG. 1).

The lifeline 214 of the fall-protection device 210 is retractable or extendable relative to the housing 212. Specifically, FIG. 6A illustrates the fall-protection device 210 in a retracted state P1 of the lifeline 214. In some examples, the lifeline 214 defines a length L3. The length L3 represents a length of the lifeline 214 extending out of the housing 212. As illustrated in FIG. 6A, the lifeline 214 has a minimum length corresponding to the retracted state P1 of the lifeline 214.

In some examples, the fall-protection device 210 further includes a drum 242 received within the housing 212 and rotatable relative to the housing 212. The drum 242 is shown schematically in FIG. 6A for the purpose of illustration. In some examples, the lifeline 214 is at least partially wound around the drum 242. In some examples, the lifeline 214 winds on or unwinds from the drum 242 as the lifeline 214 retracts or extends, respectively, relative to the housing 212. Specifically, the lifeline 214 retracts or extends relative to the housing 212 based on rotation of the drum 242 relative to the housing 212.

In some examples, the fall-protection device 210 further includes a stopper 240 coupled to and disposed around the lifeline 214. In some examples, the stopper 240 has an elliptical cross-section. However, in alternative examples, the stopper 240 may have any cross-sectional shape, e.g., square, triangular, rectangular, oval, polygonal, irregular, or the like based on application attributes.

In some examples, the stopper 240 engages with the housing 212 in the retracted state P1 of the lifeline 214, such that the lifeline 214 is restricted from further retraction into the housing 212. For example, the stopper 240 may be fixedly coupled to the lifeline 214 and may restrict the lifeline 214 from further retraction into the housing 212 from the retracted state P1.

FIG. 6B is a schematic perspective view of the fall-protection device 210 in an extended state P2 of the lifeline 214. Some components (e.g., the connector 208) of the fall-protection device 210 are not shown for the purpose of illustration. As illustrated in FIG. 6B, the lifeline 214 is extendable relative to the housing 212 from the retracted state P1 (shown in FIG. 6A) in which the length L3 (shown in FIG. 6A) of the lifeline 214 extending out of the housing 212 is minimum. Further, the stopper 240 may move along with the lifeline 214 as the lifeline 214 extends from the housing 212 further from the retracted state P1 (shown in FIG. 6A).

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below, or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example.

Various examples have been described. These and other examples are within the scope of the following claims.

1. A fall-protection device for use with a safety harness of a user, the fall-protection device comprising:
a housing configured to be connected to the safety harness;
a lifeline extending from the housing, the lifeline comprising a lifeline end distal to the housing and configured to be coupled to an anchor, wherein the lifeline is retractable or extendable relative to the housing, and wherein the lifeline is extendable relative to the housing from a retracted state in which a length of the lifeline extending out of the housing is minimum; and
a flexible cover extending from the housing and coupled to the housing and the lifeline, the flexible cover at least partially enclosing the lifeline, wherein the flexible cover contracts or expands as the lifeline retracts or extends, respectively, relative to the housing.

2. The fall-protection device of claim 1, wherein the flexible cover comprises:
a first end fixedly coupled to the housing, and
a second end distal to the first end and fixedly coupled to the lifeline proximal to the lifeline end.

3. The fall-protection device of claim 1, wherein the flexible cover comprises bellows.

4. The fall-protection device of claim 1, further comprising a connector coupled to the lifeline end, wherein the connector is configured to detachably couple the lifeline to the anchor.

5. The fall-protection device of claim 4, wherein the lifeline further comprises a loop at the lifeline end, and wherein the loop is connected to the connector.

6. The fall-protection device of claim 5, wherein the loop is disposed outside the flexible cover.

7. The fall-protection device of claim 1, further comprising a drum received within the housing and rotatable relative to the housing, wherein the lifeline is at least partially wound around the drum, and wherein the lifeline winds on or unwinds from the drum as the lifeline retracts or extends, respectively, relative to the housing.

8. The fall-protection device of claim 1, wherein the flexible cover comprises a plurality of sections disposed adjacent to each other along a length of the flexible cover, and wherein each section from the plurality of sections contracts or expands as the lifeline retracts or extends, respectively.

9. The fall-protection device of claim 8, further comprising an end wall disposed proximal to the lifeline end and fixedly coupled to the lifeline, wherein the end wall is connected to the section disposed proximal to the lifeline end, and wherein the end wall defines an end wall opening at least partially and slidably receiving the lifeline therethrough.

10. The fall-protection device of claim 8, wherein the section disposed adjacent to the housing is fixedly coupled to the housing.

11. The fall-protection device of claim 8, wherein each section has a pair of adjoining frustoconical portions tapering away from each other.

12. The fall-protection device of claim 8, further comprising a plurality of walls, wherein each wall from the plurality of walls is disposed at a junction between corresponding adjacent sections from the plurality of sections, wherein each wall is connected to the corresponding adjacent sections, and wherein each wall comprises a wall opening at least partially and slidably receiving the lifeline therethrough.

13. The fall-protection device of claim 12, wherein the plurality of walls is enclosed by the plurality of sections.

14. The fall-protection device of claim 12, wherein each wall is disc-shaped.

15. The fall-protection device of claim 1, wherein the flexible cover is expandable from a contracted state in which the lifeline is in the retracted state, and wherein a length of the flexible cover is minimum in the contracted state.

16. The fall-protection device of claim 1, wherein the flexible cover has a minimum length corresponding to the retracted state of the lifeline, such that the flexible cover restricts further retraction of the lifeline into the housing from the retracted state.

17. The fall-protection device of claim 1, wherein the flexible cover is fully disposed outside the housing.

18. The fall-protection device of claim 1, further comprising a lifeline stop coupled to and disposed around the lifeline, wherein the lifeline stop is received within the flexible cover, and wherein the lifeline stop engages with the housing in the retracted state of the lifeline, such that the lifeline is restricted from further retraction into the housing.

19. The fall-protection device of claim 18, wherein the housing comprises a housing opening, wherein the lifeline extends through the housing opening, and wherein the housing opening has a maximum width smaller than a maximum width of the lifeline stop.

20. The fall-protection device of claim 18, wherein the lifeline stop has an elliptical cross-section.

21. The fall-protection device of claim 1, wherein the flexible cover is configured to dampen a movement of the lifeline as the lifeline retracts relative to the housing.

22. The fall-protection device of claim 1, wherein the flexible cover is configured to reset a unit that is locked as the lifeline retracts relative to the housing.

23. A fall-protection system comprising:
a safety harness configured to be worn by a user;
an anchor; and
the fall-protection device of claim 1, wherein the lifeline is connected to the anchor, and wherein the housing is connected to the safety harness.
